(19) United States
(12) Patent Application Publication
(10) Pub. No.: US 2004/0238510 A1
(43) Pub. Date: Dec. 2, 2004

(54) Soldering method for metal fastening elements

(76) Inventor: Karl-Heinz Mielke, Eschweiler (DE)

Correspondence Address: HARNESS, DICKEY & PIERCE, P.L.C., P.O. BOX 828, BLOOMFIELD HILLS, MI, 48303, US

(21) Appl. No.: 10/814,479

(22) Filed: Mar. 31, 2004

Related U.S. Application Data
(63) Continuation of application No. PCT/EP02/10007, filed on Sep. 6, 2002.

(30) Foreign Application Priority Data
Sep. 7, 2001 (DE) 101 43 915.6

(51) Int. Cl. B23K 1/00

(52) U.S. Cl. 219/129

(57) ABSTRACT

The method according to the invention of connecting a metal fastening element (1) to a metal workpiece (5), wherein the fastening element (1) comprises a carrier (2), which carries a solder material (3), to which the carrier (2) is connected in an electrically conductive manner, comprises the following process steps: the solder material (3) is introduced into an indentation (8) in the carrier (2) and provided with a convex contour (4) directed towards the workpiece (5) to be soldered; a voltage is applied between the fastening element (1) and the workpiece (5) so an electrical arc (6) between solder material (3) and workpiece (5) effects a selective melting-on of the solder material (3); the fastening element (1) is pressed against the workpiece (5). The method as well as the fastening element (1), which is suitably designed for said method with a contour (4) of the solder material (3) directed towards the workpiece (5) to be soldered, is notable for the fact that a local, selective melting of the solder material (3) is achieved and unnecessary thermal loading of surrounding regions is avoided. Thus, a particularly stable solder joint is achieved between fastening element (1) and workpiece (5).

### CROSS-REFERENCE TO RELATED APPLICATIONS

The present application is a continuation of pending international patent application PCT/EP02/10007 filed on Sep. 6, 2002 which designates the United States and was published in German, and which claims priority of German patent application 101 43 915.6 filed Sep. 7, 2001.

### FIELD OF THE INVENTION

The invention relates to a method of connecting a metal fastening element to a metal workpiece, wherein the fastening element comprises a carrier, which carries a solder material, to which the carrier is connected in an electrically conductive manner.

### BACKGROUND OF THE INVENTION

It is known that solder joints as a rule are stronger than comparable weld joints. The reason for this is that with welding methods very much higher temperatures occur than with soldering methods and lead to a hardened jointing zone. The high temperatures may produce a separation of individual constituents of an alloy, a segregation as well as undesirable physical and/or chemical phases of material mixtures.

DE 4039787 describes a method of connecting two metal surfaces, whereby at least one of the opposing metal surfaces is curved convexly and so the self-alignment of the opposing faces during melting-on of the solder is improved.

The drawback of known methods is that for melting-on of the solder an extensive part of the workpieces to be joined has to be heated, which limits the scope for use of the soldering method if the temperature of such regions should not exceed a preset maximum temperature. Furthermore, the larger the region to be heated, the longer it takes to effect the heating and/or the soldering.

The object of the present invention is therefore to indicate a method of connecting a metal fastening element to a metal workpiece, which overcomes the described drawbacks of the known methods and with which in a simple and inexpensive manner a metal fastening element may be connected with minimal thermal load to a metal workpiece.

### SUMMARY OF THE INVENTION

The method according to the invention of connecting a metal fastening element to a metal workpiece, wherein the fastening element comprises a carrier, which carries a solder material, to which the carrier is connected in an electrically conductive manner, comprises the following process steps: the solder material is introduced into an indentation in the carrier and provided with a convex contour directed towards the workpiece to be soldered; a voltage is applied between the fastening element and the workpiece so an electric arc between solder material and workpiece effects a selective melting-on of the solder material; the fastening element is pressed against the workpiece.

With the aid of the method according to the invention the metal fastening element is soldered to the metal workpiece, wherein the thermal load upon the workpiece and/or the fastening element is minimised. The heat is deposited only locally in a small region predetermined by the arc. By virtue of the solder material having a convex contour directed towards the workpiece to be soldered, the arc is generated and held directly at the solder material, i.e. at the point where the heat is required. By a suitable selection of the solder material with a melting temperature below the melting temperatures of the fastening element and/or of the workpiece, a selective melting-on is achieved.

By virtue of the selectivity and localisation, thermal loading of the fastening element and of the carrier is minimised. By virtue of the low thermal load it is possible, for example, to fasten fastening elements on very thin metal sheets.

The effect achieved by the indentation in the carrier is, on the one hand, that an adequate quantity of solder material is available for the soldering process. On the other hand, the indentation, as opposed to a bulge, has the effect that a particularly thin solder layer occurs in the outer regions of the soldering point. By virtue of a thin solder layer particularly high stability of the solder joint is achieved. By virtue of high stability precisely at the outer regions of the solder contact surface a particularly high stability of the fastening element is achieved with regard to the loads and torques which have to be taken up.

As a result of the pressing of the fastening element against the workpiece a particularly intimate contact between the fastening element and the workpiece, i.e. a thin solder layer, is achieved, which leads to a high-quality solder joint. The indentation for the solder material is to be selected in such a way that sufficient solder material is available for the soldering operation but, on the other hand, the solder layer between fastening element and workpiece in the region of the indentation is as thin as possible. Thus, aside from the mechanical advantages of particularly thin solder layers the consumption of solder is also minimised.

In a development of the method according to the invention, striking of the arc is effected in that first the solder material and the workpiece are electrically short-circuited, then a voltage is applied between the fastening element and the workpiece and, finally, the fastening element and the workpiece are moved apart from one another with simultaneous formation of an arc.

By virtue of the short-circuiting and the subsequent separation of the solder material from the workpiece a well-defined arc is generated in a simple manner. By virtue of suitable adaptation of the flowing current and of the distance of the workpiece from the fastening element a local, selective melting-on of the solder material is effected. There is no unnecessary thermal loading of the fastening element and/or of the carrier in regions outside of the required solder volume.

According to a further development of the method according to the invention, after the solder material has been melted on, first the voltage between the workpiece and the fastening element is disconnected and then the fastening element is pressed against the workpiece.

As a result of disconnecting the voltage the flow of current between fastening element and workpiece is discontinued, thereby preventing a current rise and hence a short-term temperature rise during pressing of the workpiece against the fastening element. In said manner, a time characteristic of the temperature of the solder material may be precisely defined.

In a special development of the invention, the distance of the fastening element relative to the workpiece during heating is less than 4 mm, in particular less than 2 mm, preferably less than 1 mm.

The melting-on of the solder occurs either during the short-circuit or at a very low distance. It is advantageous when in the course of melting-on a drop forms and spreads itself out on the surfaces to be connected. Said spreading of the drop may be achieved by a brief lifting motion of the fastening element relative to the workpiece. It is advantageous here to utilise capillary forces and/or forces of adhesion of the solder to the workpiece and/or to the fastening element in order to achieve a good wetting of the fastening element and/or of the workpiece.

According to a special development of the method according to the invention, by means of the arc a drop of solder material is formed, which wets the fastening element and the workpiece, and then the solder material is heated further during the short-circuit. By virtue of the formation of the drop a wetting of the surfaces to be connected to one another is achieved and is effected in a particularly uniform manner by virtue of the subsequent resistance heating during the short-circuit.

The fastening element according to the invention to be soldered on a workpiece comprises a carrier having an end, which is to be soldered on and has an indentation filled with a solder material, wherein the solder material has a contour, which is convex and directed towards the workpiece to be soldered.

The indentation has the function of a vessel for receiving the solder material. It provides enough space to hold a sufficient quantity of solder material for the soldering operation. By virtue of the convex contour of the solder material directed towards the workpiece it is ensured that the arc produced during the soldering operation is struck directly at the solder material. By virtue of the localization of the arc at the solder material a localised heating of the solder material is achieved. As a result, unnecessary thermal loading of the workpiece and/or of the fastening element in regions, where it is not required, is avoided. Both the indentation and the contour respectively may be of a pointed or rounded-off construction. The convex construction of the contour is to be fashioned in such a way that the solder material extends far enough beyond the fastening element to guarantee reliable localisation of the arc at the salient part of the solder material. It should however not protrude too much in order to minimise the quantity of solder required and to avoid excessively thick solder layers.

In a special development of the invention, the fastening element is a stud. In a further special development of the invention, the fastening element is a nut. The indentation in the fastening element may be produced, for example, by a trough disposed in a centred manner or by a plurality of smaller troughs or by grooves. In a particularly special development of the fastening element according to the invention, the indentation is of an annular or cylindrical construction.

In a special development of the invention, the contour projects in a pyramidal manner. As with the indentation, the contour may be formed, for example, by a single bulge or by a plurality of smaller bulges or by rectilinearly intersecting or curved webs. In a suitable manner the contour is selected in such a way that as uniform as possible a wetting of the surfaces to be connected by solder is guaranteed.

The method according to the invention of providing solder on a fastening element is characterised in that an end, which is to be soldered on, of the carrier is provided with solder with the aid of a flow soldering technique. With the aid of the flow soldering technique a carrier for receiving a solder material on the fastening element is provided with solder.

In an advantageous development of the method according to the invention, the end provided with solder is then cold-worked and the solder material is provided with a convex contour directed towards the workpiece to be soldered. By a subsequent cold-working of the end provided with solder it is possible to achieve any shape of the convex contour, in particular the formation of a bulge or a plurality of bulges. The bulges may take the shape of a web or of a number of webs and/or the shape of intersecting, curved and/or circular webs.

Further features and advantageous developments are described with reference to the accompanying drawings. The drawings are intended not to restrict the subject matter of the invention but to illustrate the invention merely by way of example.

### BRIEF DESCRIPTION OF DRAWINGS

The drawings show diagrammatically in longitudinal section:

FIG. 1 a preferred fastening element according to the invention in the form of a stud;

FIG. 2 a fastening element according to the invention in the form of a nut;

FIG. 3a to 3c the sequence of a method according to the invention of fastening a fastening element to a workpiece;

FIG. 4a to 4c an alternative embodiment of the method according to the invention of connecting a fastening element to a workpiece.

### DETAILED DESCRIPTION OF THE PREFERRED EMBODIMENT

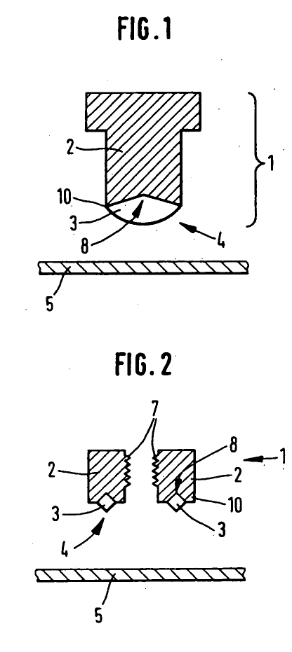

FIG. 1 shows a particularly preferred embodiment of a fastening element 1 according to the invention in the form of a stud having a carrier 2, which has an end 10 containing an indentation 8. A solder material 3 is introduced into the indentation 8 with the aid of a flow soldering technique. In said case, the solder material 3 is arranged in such a way that it has a contour 4, which is formed convexly in relation to a workpiece 5. The solder material 3 therefore extends beyond the carrier 2. The solder material 3 as part of the fastening element 1 is therefore at the shortest distance from the workpiece 5.

FIG. 2 shows a fastening element 1 according to the invention in the form of a nut, which is attachable by soldering and comprises a carrier 2, which contains an indentation 8 for receiving a solder material 3, which is formed with a contour 4 extending in the direction of a workpiece 5. The solder material 3 is the part of the fastening element situated closest to the workpiece 5. The carrier 2 has a thread 7 for establishing a screw-connection to other parts.

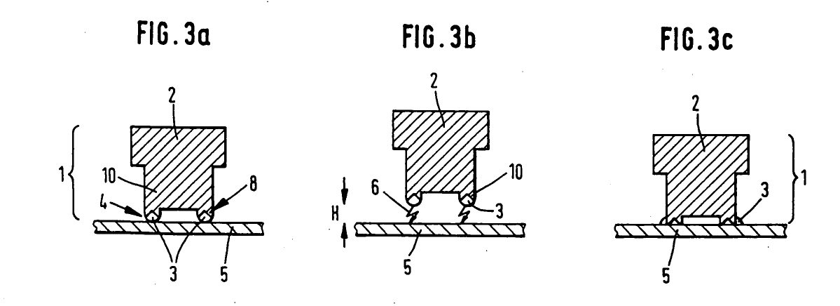

FIGS. 3a to 3c illustrate the method according to the invention of connecting a metal fastening element to a metal workpiece. In said case, the fastening element 1 is brought by a carrier 2, which has an indentation 8 which, having been filled with solder material 3, has a convex contour 4 directed towards a workpiece 5, into contact with the workpiece 5 in that the solder material 3 is placed by its contour 4 onto the workpiece 5. By applying a voltage between the fastening element 1 and the workpiece 5 a short-circuit is produced, which leads to a flow of current through the surfaces which are to be joined together. According to FIG. 3b the fastening element 1 is then moved apart from the workpiece 5, wherein because of the voltage and the current flow an arc 6 is formed between the solder material 3 and the workpiece 5. The arc 6 is struck at the convex contour 4 and heats up the solder material 3 beyond the melting temperature. The fastening element 1 is held at a distance H from the workpiece 5. The distance H varies as a function of time in accordance with the process parameters. FIG. 3c shows the fastening element 1 which, after uniform heating of the solder material 3, has been pressed onto the workpiece 5. Both the indentation 8 and the contour 4 are of an annular construction.

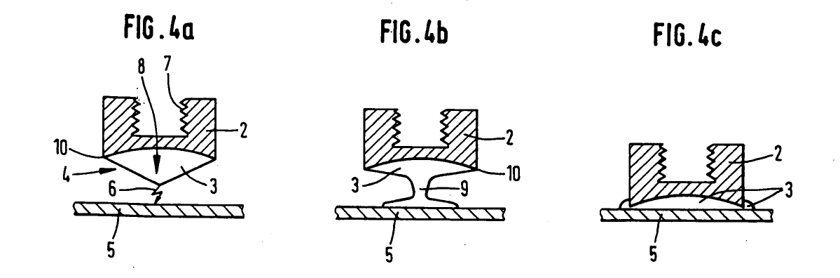

FIGS. 4a to 4c illustrate a method according to the invention of connecting a fastening element 1, wherein the fastening element 1 is a nut, which comprises a thread 7 and a carrier 2 with an indentation 8, which is filled with solder material 3. The solder material 3 according to FIG. 4a has a convex contour 4, which is directed towards a workpiece and extends in a pyramidal manner towards the workpiece 5. Between solder material 3, in particular the vertex of the pyramid, and the workpiece 5 an arc 6 is struck by applying a voltage between the carrier 2 and the workpiece 5. The arc 6 heats the solder material 3 locally. This leads, when the melting temperature of the solder material 3 is exceeded, to the formation of a drop 9, which wets the workpiece 5 in the manner shown in FIG. 4b. In the case of short distances H of 1 mm, the drop 9 simultaneously wets both the workpiece 5 and the fastening element 1, which is advantageous for a high-quality solder joint. When the drop 9 wets both the workpiece 5 and the fastening element 1, the solder material 3 is heated by the flow of electric current and/or by the resistance heat associated therewith. The value of the voltage and/or of the current, the distance and the periods of time determine the temperature of the solder material 3, which is namely to lie above the melting temperature of the solder material 3 but below the melting temperatures of the carrier 2 and/or of the workpiece 5. In FIG. 4c the carrier 2 with the molten solder material is pressed onto the workpiece 5 and the current is switched off.

The method according to the invention of connecting a metal workpiece 5 to a fastening element 1 is notable for the fact that, by virtue of the solder material 3 having a convex contour 4 directed towards a workpiece 5, an arc 6 is produced locally directly at the solder material 3 and leads to selective melting of the solder material 3, wherein thermal impairment of the workpiece 5 and/or of the fastening element 1 in adjacent regions is avoided. Thus, a particularly stable solder joint is achieved between fastening element 1 and workpiece 5.

1. Method of connecting a metal fastening element to a metal workpiece, wherein the fastening element comprises a carrier, which carries a solder material, to which the carrier is connected in an electrically conductive manner, comprising the following process steps:
a. the solder material is introduced into an indentation in the carrier and provided with a convex contour directed towards the workpiece to be soldered;
b. a voltage is applied between the fastening element and the workpiece so an electrical arc between solder material and workpiece effects a selective melting-on of the solder material;
c. the fastening element is pressed against the workpiece.

2. Method according to claim 1, characterised in that striking of the arc is effected in that first the solder material and the workpiece are electrically short-circuited, then a voltage is applied between the fastening element and the workpiece and, finally, the fastening element and the workpiece are moved apart from one another with simultaneous formation of an arc.

3. Method according to claim 1, characterised in that, after the solder material has been melted on, first the voltage between the workpiece and the fastening element is disconnected and then the fastening element is pressed against the workpiece.

4. Method according to claim 1, characterised in that the distance of the fastening element relative to the workpiece is less than 4 mm.

5. Method according to claim 4, characterised in that by means of the arc a drop of solder material is formed, which wets the fastening element and the workpiece, and then the solder material is heated further during the short-circuit.

6. Fastening element to be soldered on a workpiece, having a carrier with an end, which is to be soldered on and comprises an indentation filled with a solder material, wherein the solder material has a contour, which is of a convex construction and directed towards the workpiece to be soldered.

7. Fastening element according to claim 6, characterised in that the fastening element is a stud.

8. Fastening element according to claim 6, characterised in that the fastening element is a nut.

9. Fastening element (1) according to claim 6, characterised in that the indentation is of an annular or cylindrical construction.

10. Fastening element according to claim 6, characterised in that the contour projects in a pyramidal manner.

11. Method according to claim 1, characterised in that an end of the carrier to be soldered on is provided with solder with the aid of a flow soldering technique.

12. Method according to claim 11, characterised in that the end provided with solder is then cold-worked and the solder material is provided with a convex contour directed towards the workpiece to be soldered.
